(19) United States
(12) Patent Application Publication
(10) Pub. No.: US 2018/0037693 A1
(43) Pub. Date: Feb. 8, 2018

(54) POLYBUTADIENOLS FOR PRODUCING GLASSY POLYURETHANES

(71) Applicant: BASF SE, Ludwigshafen am Rhein (DE)

(72) Inventors: Berend Eling, Lemfoerde (DE); Jan Dilcher, Hamburg (DE); Jessica Rudnik, Hamburg (DE); Gerrit Luinstra, Hamburg (DE)

(21) Appl. No.: 15/555,097

(22) PCT Filed: Mar. 3, 2016
(86) PCT No.: PCT/EP2016/054486

§ 371 Date: Sep. 1, 2017

(30) Foreign Application Priority Data
Mar. 6, 2015 (EP) 15157996.8

(51) Int. Cl. C08G 18/62; C08F 8/12; C08G 18/10; C08G 18/76; C08G 18/22; C08F 8/08; C08F 236/06

(52) U.S. Cl. CPC C08G 18/6204; C08F 8/08; C08F 8/12; C08F 236/06; C08G 18/7671; C08G 18/222; C08G 18/10

(57) ABSTRACT

The invention relates to a process for the production of polybutadienols from polybutadienes with number-average molar mass from 300 to 2000 g/mol comprising from 20 to 50% of 1,4 double bonds and from 50 to 80% of 1,2 vinylic and 1,2 cyclovinylic double bonds, based on the quantity of all of the double bonds, comprising the steps of
i) epoxidation of some or all of the 1,4 double bonds with an epoxidizing reagent which selectively epoxidizes 1,4 double bonds,
ii) reaction of the epoxidized polybutadiene with an alcohol or water to give a polybutadienol.

The invention relates to a process for the production of polybutadienols, to the polybutadienols per se, to use of these for the production of polyurethanes that are glassy at room temperature with glass transition temperature at least 15° C., and also to the glassy polyurethanes produced with the polybutadienols as polyol component.

Hard, glassy polymers made of polybutadienes have been known for a long time. Production of these preferably uses epoxidized polybutadienes. Hardening is achieved via addition of amines (see U.S. Pat. No. 2,876,214 or DE 2833786) or of carboxylic acid derivatives (see U.S. Pat. No. 3,371,070 or U.S. Pat. No. 3,436,377), optionally in the presence of alcohols. Hardening usually requires temperatures above 100° C., and the processing times are from 1 to 2 hours. In order to obtain glassy resins, high epoxidation levels of the polybutadiene are required. However, when epoxide contents are high unintended side-reactions can occur even before epoxidation is complete.

Hydrophobic properties of the polymers are affected by the chemical nature of the materials. Polybutadienes, being hydrocarbons, are nonpolar and are therefore extremely hydrophobic. The use of polybutadiene provides water-repellent materials with little swelling in water. For use in polyurethanes, polybutadienes must have hydrogen atoms that are reactive toward isocyanate groups, examples being hydroxy groups. Polyurethanes derived from polybutadienols have the advantage that the materials produced therefrom are not susceptible to hydrolysis. Although the castor oil used as polyol is hydrophobic, the ester bond of the triglyceride is susceptible to hydrolysis.

Polybutadienols can be reacted with isocyanates in order to obtain crosslinked structures: liquid hydroxy-terminated polybutadienes (HTPB) have been known for a long time, and are used as polyol components in polyurethanes. Commercially available products are obtained via free-radical polymerization (see U.S. Pat. No. 3,965,140) or ionic polymerization (see DD 160223) of 1,3-butadiene. In order to obtain HTPB it is necessary to use particular reagents as starters and terminators. The number of functional groups in the polyols obtained differs, depending on the production process. These polybutadienols are not very suitable for the production of glassy materials, because they have significant proportions of flexible 1,4 double bonds which lead to crosslinked materials with glass transition temperatures below 25° C. (see Review and references in J. Macromol. Sci. Part A 2013, 50, 128-138).

Polybutadienols can be produced from unfunctionalized polybutadiene oligomers. One possible production method is provided by polymer-analogous reactions via partial epoxidation of available double bonds, followed by opening of the epoxides by suitable nucleophils, for example in particular alcohols or amines. The number of functional groups can be adjusted as desired by way of the conversion in the polymer-analogous reaction steps. The epoxidation of polydienes with percarboxylic acids is summarized by way of example in Perera, Ind. Eng. Chem. Res 1988, 27, 2196-2203. Reaction of polybutadienes with percarboxylic acids can give epoxidized polybutadienes. The percarboxylic acid can be used directly here or generated in situ from the carboxylic acid and hydrogen peroxide, as described in U.S. Pat. No. 2,829,135. Formic acid is often used for the epoxidation reaction, being the simplest carboxylic acid. Performic acid formed in situ epoxidizes almost exclusively 1,4 double bonds in the polybutadiene.

The quantities of reactive hydroxy groups in polybutadienols obtained via polymer-analogous reactions differ, depending on the level of epoxidation and epoxide-opening. The number of hydroxy groups also determines the viscosity of the polyol. Crosslinking of the polybutadienols can be brought about at moderate temperatures below 80° C. by a simple preparative method via reaction with isocyanates. The properties of the resultant polyurethane, in particular the glass transition temperature and mechanical properties thereof, are controlled via the number of reactive hydroxy groups per unit of mass of the polybutadienol.

It is an object of the invention to provide polyurethanes which have glassy properties at room temperature, and also to provide polybutadienols suitable for the production of the glassy polyurethanes. The glass transition temperature, determined by means of DSC, of the polyurethane, produced with an isocyanate index of 100, is intended to be at least 15° C. In particular, it is an object of the invention to provide hydroxy-functionalized short-chain polybutadiene oligomers for the production of glassy polyurethanes with very low swelling values in water and long pot lives (open times) for uses by way of example as coating material, reactive adhesive, or foam. It is moreover an object of the invention to provide polybutadienols which, even when hydroxy equivalent masses extend upward as far as 750 g, provide glassy materials. The mixtures of polyol and isocyanate are intended to allow long pot lives, and to give polyurethanes with hydrophobic properties.

The object is achieved via a process for the production of polybutadienols from polybutadienes with number-average molar mass from 300 to 2000 g/mol comprising from 20 to 50% of 1,4 double bonds and from 50 to 80% of 1,2 vinylic and 1,2 cyclovinylic double bonds, based on the quantity of all of the double bonds, comprising the steps of
(i) epoxidation of some or all of the 1,4 double bonds with an epoxidizing reagent which selectively epoxidizes 1,4 double bonds,
(ii) reaction of the epoxidized polybutadiene with an alcohol or water to give a polybutadienol.

Epoxidation of terminal 1,2 vinyl bonds is possible only with aromatic peracids such as meta-chloroperbenzoic acid (see Abdullin et. al. in Polymer Science Series B 2013, 55, 349-354), or else with transition metal compounds (see Wang et al. in J. Mol. Cat. A 2009, 309, 89-94). In the case of polybutadienols of the invention, the proportion of 1,4 double bonds is intended not to be excessive, because although that assists functionalization high conversions in the epoxidation reaction are required to obtain glassy polyurethanes. A high proportion of 1,2 double bonds provides the necessary stiffness. However, a precondition for glass transition temperatures above 15° C. is a crosslinking reaction which requires a certain proportion of 1,4 double bonds in the polymer structure.

Epoxidized polybutadienes can be reacted to give hydroxy-functionalized polybutadienes by using suitable nucleophils, for example water, as described in PDE 10 2012 017055, alcohols, as described in DE 35 11 513, or amines, as described in DE 25 54 093. However, amines are unsuitable for the epoxide-ring-opening of the polybutadiene epoxides (step (ii)) because they have a catalytic effect in the subsequent reaction of the polybutadienols with isocyanates.

Unlike HTPB, post-functionalized polybutadiene polyols do not have the hydroxy groups selectively as terminal groups, but instead have them randomly distributed along the main chain of the polybutadiene. In comparison with terminal epoxides, the opening of the disubstituted epoxy groups resulting from the epoxidation of 1,4 double bonds is more chemically demanding, and requires comparatively harsh conditions, for example temperatures above 150° C. and/or high pressures, or strongly acidic or strongly basic catalysts. Suitable catalysts for this reaction are strong acids such as mineral acids, as described in EP 0 585 265, boron trifluoride, as described in U.S. Pat. No. 5,242,989, trifluoroacetic acid, as described in DE 25 54 093, or trifluoromethanesulfonic acid, as described in WO 96/20234 and Li, J. Macromol. Sci, Part A, 2013, 50, 297-301, and also bases such as potassium hydroxide, as described in DE 35 11 513.

The production of the polybutadiene polyol is therefore composed of two reaction steps, namely (i) epoxidation and (ii) ring-opening of the epoxide ring by an alcohol.

Production of the polybutadienols of the invention uses unmodified polybutadienes with number-average molar mass from 300 to 2000 g/mol, preferably from 500 to 1500 g/mol. The microstructure of the polybutadiene oligomers has 1,4 double bonds, 1,2 vinylic double bonds, and 1,2 cyclovinylic double bonds. These polybutadienes used in the invention comprise from 20 to 50% of 1,4 double bonds, preferably from 25 to 40%. Accordingly, the polybutadienes have from 50 to 80% of 1,2 vinylic and 1,2 cyclovinylic double bonds, preferably from 60 to 75%.

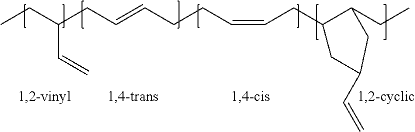

The polybutadiene oligomers are by way of example epoxidized with formic acid and hydrogen peroxide. The 1,4 double bonds of the oligomer are reacted to some extent or completely to give the epoxide. The level of epoxidation is selected in such a way that the required number of hydroxy groups can be produced.

Monoalcohols or polyols are used as nucleophils for the opening of the epoxidized polybutadienols. Preference is given to alcohols which comprise only one hydroxy group per molecule (monoalcohols). The alcohols can be primary or secondary alcohols, preferably being primary alcohols. Preference is given to primary monoalcohols such as ethanol, 1-propanol, and 1-butanol. Preference is given to alcohols in which the epoxidized polybutadiene is soluble, particular preference being given to 1-propanol. The reaction can also be carried out in a suitable solvent in which the epoxidized polybutadienol, the alcohol and, respectively, water, and the catalyst are soluble.

In one embodiment of the invention, the epoxide ring is opened in the presence of trifluoromethanesulfonic acid as catalyst. Other suitable catalysts are strong acids, for example sulfuric acid, methanesulfonic acid, or Lewis acids, for example tin(II) chloride.

The polybutadienols obtained via polymer-analogous reactions comprise different quantities of reactive hydroxy groups, said quantities depending on the conversions in the epoxidation and epoxide-opening reactions. The hydroxy equivalent mass of the resultant polybutadienols is generally from 250 to 750 g, preferably from 300 to 600 g.

The opening of disubstituted epoxy groups by alcohols gives polybutadiene polyols having exclusively secondary OH groups. The content of secondary OH groups in the polybutadienols produced in the invention, based on all the OH groups, is generally at least 70%, preferably at least 90%, particularly preferably at least 95%. In order to obtain reactive systems which allow long pot lives, secondary hydroxy groups are advantageous, because the reaction with isocyanates in principle proceeds more slowly than with primary hydroxy groups.

The glassy polyurethanes of the invention can be obtained from polybutadienols having hydroxy equivalent masses that are generally from 250 to 750 g, where these comprise a high proportion of repeating units having 1,2 vinylic and 1,2 cyclovinylic double bonds. The groups comprising 1,2 vinylic and 1,2 cyclovinylic double bonds protruding from the polymer chain in the microstructure restrict molecular motion and increase the glass transition temperature of the polybutadienols, and also of the crosslinked polyurethanes produced therefrom.

The present invention also provides polyurethanes with glass transition temperature at least 20° C., obtainable via reaction of
a) polyisocyanates A with
b) polybutadienols B of the invention,
c) optionally other compounds C having at least 2 hydrogen atoms reactive toward isocyanates,
d) optionally catalysts D,
e) optionally water E,
f) optionally physical blowing agents F,
g) optionally other auxiliaries and/or additives G.

It is preferable that the glass transition temperature of the polyurethanes is at least 15° C., particularly at least 25° C.

The polyurethanes of the invention can be unfoamed, solid materials with density that is generally greater than 1000 kg/m³, or foams. For the production of foams it is preferable that the blowing agent used is water (component E), which reacts with isocyanate groups with elimination of carbon dioxide. It is also possible to use what are known as physical blowing agents in combination with, or instead of, water. These are compounds that are inert in relation to the starting components and that are mostly liquid at room temperature, and that vaporize under the conditions of the urethane reaction. The boiling point of the physical blowing agents is preferably below 100° C.

For the production of the polyurethane reaction mixture of the invention, the organic polyisocyanates A and the components comprising the compounds having hydrogen atoms reactive toward isocyanates are reacted in quantities such that the equivalence ratio of NCO groups to the entirety of the reactive hydrogen atoms is from 0.5:1 to 4:1 (corresponding to an isocyanate index of from 50 to 350), preferably from 0.8:1 to 2:1, and particularly preferably from 0.9:1 to 1.5:1.

The organic and/or modified polyisocyanates A used for the production of the polyurethanes of the invention comprise the aliphatic, cycloaliphatic, and aromatic di- or polyfunctional isocyanates known from the prior art, and also any desired mixture thereof. Examples are methanediphenyl 4,4′-diisocyanate, methanediphenyl 2,4′-diisocyanate, mixtures of monomeric methanediphenyl diisocyanates with homologs of methanediphenyl diisocyanate having a larger number of rings (polymer MDI), tetramethylene diisocyanate, hexamethylene diisocyanate (HDI), mixtures of hexamethylene diisocyanates with homologs of hexamethylene diisocyanate having a larger number of rings (multi-ring HDI), isophorone diisocyanate (IPDI), tolylene 2,4- or 2,6-diisocyanate (TDI) and mixtures of the isocyanates mentioned. It is preferable to use tolylene diisocyanate (TDI), diphenylmethane diisocyanate (MDI), and in particular mixtures of diphenylmethane diisocyanate and polyphenylene polymethylene polyisocyanates (crude MDI). The isocyanates can also have been modified, for example via incorporation of uretdione, carbamate, isocyanurate, carbodiimide, allophanate, and in particular urethane groups. It is also possible here to use the isocyanate component A in the form of isocyanate prepolymers containing isocyanate groups. Said polyisocyanate prepolymers are obtainable by reacting polyisocyanates described above as component A1 by way of example at temperatures of from 30 to 100° C., preferably about 80° C., with polyols A2 to give the prepolymer.

It is preferable to produce the prepolymers by reacting 4,4′-MDI with uretonimine-modified MDI and with commercially available polyols based on polyesters, for example deriving from adipic acid or polyethers, for example deriving from ethylene oxide and/or propylene oxide.

Polyols A2 are known to the person skilled in the art and are described by way of example in “Kunststoffhandbuch, Band 7, Polyurethane” [Plastics handbook, volume 7, Polyurethanes], Carl Hanser Verlag, 3rd edition 1993, chapter 3.1. It is preferable here to use polyetherols as polyols A2. During the production of the isocyanate prepolymers, conventional chain extenders or crosslinking agents are optionally added as component A3 to the polyols A2 mentioned. The substances described under B2 below are chain extenders of this type. It is particularly preferable to use the following as chain extenders: 1,4-butanediol, propylene 1,2-glycol, 1,3-butanediol, dipropylene glycol, tripropylene glycol, and/or propylene glycols with molecular weight up to 500. It is preferable here that the ratio of organic polyisocyanates Al to polyols A2 and chain extenders A3 is selected in such a way that the NCO content of the isocyanate prepolymer is from 10 to 28%, particularly from 14 to 25%.

Polyols A2 used can also be the polybutadienols B, and the other compounds C mentioned below.

In one embodiment of the present invention the glassy polyurethanes are unfoamed polyurethanes. These are obtainable via reaction of the components A, B, optionally C, optionally D, and optionally G in the quantities stated above, in the absence of blowing agents E and F.

In another embodiment of the present invention, the glassy polyurethanes are foams. These are obtainable via reaction of the components A, B, optionally C, optionally D, and optionally G, in the presence of water E as blowing agent and/or of a physical blowing agent F. Operations are generally carried out in the presence of from 0.1 to 30 parts by weight of the physical blowing agent, preferably from 0.2 to 15 parts by weight, and/or in the presence of from 0.05 to 3.0 parts by weight of water, preferably from 0.1 to 1.0 parts by weight of water.

The molar mass of suitable other compounds C having at least two hydrogen atoms reactive toward isocyanates is generally at least 58 g/mol. It is possible here to use any of the compounds with molar mass at least 58 g/mol that have at least two reactive hydrogen atoms and that are known for polyurethane production. The functionality of these is by way of example from 2 to 8, with molar mass from 58 to 12 000 g/mol. It is therefore possible by way of example to use polyether polyamines and/or polyols selected from the group of the chain extenders, polyether polyols, polyester polyols, and mixtures thereof.

The other polyols C preferably used are chain extenders, polyetherols, polycarbonate polyols, and/or polyesterols with molar masses from 58 to 12 000 g/mol.

Chain extenders used are preferably compounds with molar mass smaller than 300 g/mol, for example compounds having 2 hydrogen atoms reactive toward isocyanates. These can be used individually or else in the form of mixtures. Examples of those that can be used are aliphatic, cycloaliphatic, and/or araliphatic diols having from 2 to 14, preferably from 2 to 10, carbon atoms, in particular alkylene glycols. Other suitable compounds are low-molecular-weight polyalkylene oxides which contain hydroxy groups and are based on ethylene oxide and/or on propylene 1,2-oxide. Preferred chain extenders are (mono)ethylene glycol, 1,2-propanediol, 1,3-propanediol, pentanediol, tripropylene glycol, 1,10-decanediol, 1,2-, 1,3- and 1,4-dihydroxycyclohexane, diethylene glycol, triethylene glycol, dipropylene glycol, 1,4-butanediol, 1,6-hexanediol, 2-methylpropane-1,3-diol, 2,2-dimethylpropane-1,3-diol, bisphenol A bis(hydroxyether), N-phenyldiethanolamine, and bis(2-hydroxyethyl)hydroquinone. Particularly preferred chain extenders used are monoethylene glycol, diethylene glycol, 2-methyl-1,3-propanediol, 1,4-butanediol, 1,5-pentanediol, 1,6-hexanediol, and mixtures thereof, and very particular preference is given to 1,4-butanediol and monoethylene glycol.

It is preferable that molar masses of the polyetherols, polycarbonate polyols, and/or polyesterols are from 150 to 12 000 g/mol, and that their average functionality is from 2 to 8. It is preferable that other polyols C used are exclusively polyetherols and/or polyester polyols.

With respect to polyetherols and/or polyester polyols, a distinction is drawn between polyols used for rigid foam on the one hand and those used for elastomers or flexible foam on the other hand. The functionality of polyols for typical rigid foam applications is from 2 to 8, with molecular weight from 150 to 2000. The functionality of polyols for typical elastomer applications and typical flexible foam applications is from 2 to 3, with molecular weight from 2000 to 6000. Polyol C is preferably a chain extender or a polyol with functionality from 2 to 8 and molecular weight from 150 to 2000.

The polyetherols C are produced by known processes. By way of example, they can be produced via anionic polymerization of alkylene oxides having from 2 to 4 C atoms with alkali metal hydroxides, e.g. sodium hydroxide or potassium hydroxide, or with alkali metal alcoholates, e.g. sodium methanolate, sodium ethanolate or potassium ethanolate, or potassium isopropanolate, as catalysts, and with addition of at least one starter molecule having from 2 to 8, preferably from 2 to 6, reactive hydrogen atoms, or via cationic polymerization with Lewis acids, such as antimony pentachloride, boron fluoride etherate, inter alia, or bleaching earth as catalysts. It is also possible to produce polyether polyols via double metal cyanide catalysis from one or more alkylene oxides having from 2 to 4 carbon atoms. It is also possible to use tertiary amines as catalyst, for example triethylamine, tributylamine, trimethylamine, dimethylethanolamine, imidazole, or dimethylcyclohexylamine. It is also possible to incorporate monofunctional starters into the structure of the polyether for specific intended purposes.

Examples of suitable alkylene oxides are tetrahydrofuran, propylene 1,3-oxide, butylene 1,2- and 2,3-oxide, styrene oxide, and preferably ethylene oxide and propylene 1,2-oxide. The alkylene oxides can be used individually, in alternating succession, or in the form of mixtures.

Starter molecules that can be used are by way of example: water, aliphatic and aromatic, optionally N-mono-, N,N-, and N,N′-dialkyl-substituted diamines having from 1 to 4 carbon atoms in the alkyl moiety, for example optionally mono- and dialkyl-substituted ethylenediamine, diethylenetriamine, triethylenetetramine, 1,3-propylenediamine, 1,3- and 1,4-butylenediamine, 1,2-, 1,3-, 1,4-, 1,5-, and 1,6-hexamethylenediamine, phenylenediamine, 2,3-, 2,4-, and 2,6-tolylenediamine (TDA), and 4,4′-, 2,4′-, and 2,2′-diaminodiphenylmethane (MDA), and polymeric MDA. Other starter molecules that can be used are: alkanolamines, e.g. ethanolamine, N-methyl- and N-ethylethanolamine, dialkanolamines, e.g. diethanolamine, N-methyl- and N-ethyldiethanolamine, trialkanolamines, e.g. triethanolamine, and ammonia. It is preferable to use polyhydric alcohols such as ethanediol, 1,2- and 2,3-propanediol, diethylene glycol, dipropylene glycol, 1,4-butanediol, 1,6-hexanediol, glycerol, trimethylolpropane, pentaerythritol, sorbitol, and sucrose, and mixtures thereof. The polyether polyols can be used individually or in the form of mixtures.

Other polyesterols C used can be polyesterols usually used in polyurethane chemistry. Polyesterols C can by way of example be produced from organic dicarboxylic acids having from 2 to 12 carbon atoms, preferably aliphatic dicarboxylic acid having from 4 to 6 carbon atoms, and from polyhydric alcohols, preferably diols, having from 2 to 12 carbon atoms, preferably from 2 to 6 carbon atoms. Examples of dicarboxylic acids that can be used are: succinic acid, glutaric acid, adipic acid, suberic acid, azelaic acid, sebacic acid, decanedicarboxylic acid, maleic acid, fumaric acid, phthalic acid, isophthalic acid, and terephthalic acid. The dicarboxylic acids here can be used either individually or else in a mixture. It is also possible to use the corresponding dicarboxylic acid derivatives, e.g. dicarboxylic esters of alcohols having from 1 to 4 carbon atoms, or dicarboxylic anhydrides, instead of the free dicarboxylic acids. It is preferable to use dicarboxylic acid mixtures made of succinic, glutaric, and adipic acid in quantitative proportions that are by way of example from 20 to 35: from 35 to 50: from 20 to 32 parts by weight, and in particular adipic acid. Examples of di- and polyhydric alcohols, in particular diols, are: ethanediol, diethylene glycol, 1,2- or 1,3-propanediol, dipropylene glycol, 1,4-butanediol, 1,5-pentanediol, 1,6-hexanediol, 1,10-decanediol, glycerol, and trimethylolpropane. It is preferable to use ethanediol, diethylene glycol, 1,4-butanediol, 1,5-pentanediol, and 1,6-hexanediol. In one particular embodiment, polyol B is used as alcohol component. It is also possible to use polyester polyols derived from lactones, e.g. caprolactone, or hydroxycarboxylic acids, e.g. hydroxycaproic acid. It is moreover possible to use polyesterols made of caprolactone and/or hydroxycarboxylic acids and polyol B.

For preparation of the polyester polyols, the organic, e.g. aromatic, and preferably aliphatic, polycarboxylic acids and/or their derivatives and polyhydric alcohols can be polycondensed without a catalyst or preferably in the presence of esterification catalysts, advantageously in an atmosphere composed of inert gas, for example nitrogen, carbon monoxide, helium, argon, etc., in the melt at temperatures which are from 150 to 250° C., preferably from 180 to 220° C., optionally at reduced pressure, until the desired acid number has been reached, this preferably being smaller than 10, particularly preferably smaller than 2. According to one preferred embodiment, the esterification mixture is polycondensed at the abovementioned temperatures until the acid number is from 80 to 30, preferably from 40 to 30, at atmospheric pressure, and then at a pressure which is smaller than 500 mbar, preferably from 50 to 150 mbar. Examples of esterification catalysts that can be used are iron catalysts, cadmium catalysts, cobalt catalysts, lead catalysts, zinc catalysts, antimony catalysts, magnesium catalysts, titanium catalysts, and tin catalysts, in the form of metals, of metal oxides, or of metal salts. However, the polycondensation process can also be carried out in a liquid phase in the presence of diluents and/or entrainers, e.g. benzene, toluene, xylene, or chlorobenzene, for the azeotropic removal of the water of condensation by distillation. The polyester polyols are advantageously produced by polycondensing the organic polycarboxylic acids and/or polycarboxylic acid derivatives and polyhydric alcohols in a molar ratio of 1: from 1 to 2, preferably 1: from 1.05 to 1.5.

The functionality of the resultant polyester polyols is preferably from 2 to 4, in particular from 2 to 3, their number-average molar mass being from 200 to 3000 g/mol, preferably from 300 to 2000 g/mol.

Polyols particularly suitable as component C are polyols based on oils and on fats, for example castor oil, and on other hydroxy-modified oils which are obtainable by way of example with trademark Sovermol® from BASF SE, Ludwigshafen, DE.

Catalysts D used for the production of the polyurethanes are preferably compounds which greatly accelerate the reaction of the hydroxylated compounds of component B, and optionally C, with the organic, optionally modified polyisocyanates A. Examples that may be mentioned are amidines, for example 2,3-dimethyl-3,4,5,6-tetrahydropyrimidine, tertiary amines, such as triethylamine, tributylamine, dimethylbenzylamine, N-methyl-, N-ethyl-, or N-cyclohexylmorpholine, N,N,N′,N′-tetramethylethylenediamine, N,N,N′,N′-tetramethylbutanediamine, tetramethylbutanediamine, N,N,N′N-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane, and preferably 1,4-diazabicyclo[2.2.2]octane, and alkanolamine compounds, such as triethanolamine, triisopropanolamine, N-methyl- and N-ethyldiethanolamine, and dimethylethanolamine. Organometallic compounds can also be used, preferably organotin compounds, such as tin(II) salts of organic carboxylic acids, e.g. tin(II) acetate, tin(II) octoate, tin(II) ethylhexoate, and tin(II) laurate, and the dialkyltin(IV) salts of organic carboxylic acids, e.g. dibutyltin diacetate, dibutyltin dilaurate, dibutyltin maleate, and dioctyltin diacetate, and also bismuth carboxylates, such as bismuth(III) neodecanoate, bismuth 2-ethylhexanoate, and bismuth octanoate, ora mixture thereof. The organometallic compounds can be used alone or preferably in combination with strongly basic amines. If component (b) involves an ester, it is preferable to use exclusively amine catalysts.

It is preferable to use from 0.001 to 5% by weight, in particular from 0.05 to 2% by weight, of catalyst or catalyst combination, based on the total weight of components B and, if present, C.

The glassy polyurethanes of the invention with glass transition temperature at least 15° C. can be unfoamed, solid materials with density generally greater than 1000 kg/m³, or foams. Water (component E) is preferably used as blowing agent for the production of foams, and reacts with isocyanate groups with elimination of carbon dioxide. It is also possible to use what are known as physical blowing agents, in combination with water or instead of water. These are compounds that are inert to the starting components, mostly being liquid at room temperature and vaporizing under the conditions of the urethane reaction. Boiling point is preferably below 100° C.

The physical blowing agents F are mostly selected from the group consisting of alkanes and/or cycloalkanes having at least 4 carbon atoms, dialkyl ethers, esters, alcohols, ketones, acetals, fluoroalkanes having from 1 to 8 carbon atoms, and tetraalkylsilanes. Examples that may be mentioned are: propane, n-butane, iso- and cyclobutane, n-, iso-, and cyclopentane, cyclohexane, dimethyl ether, methyl ethyl ether, methyl butyl ether, methyl formate, tert-butanol, acetone, and also fluoroalkanes, where these can be degraded in the troposphere and therefore are not detrimental to the ozone layer, examples being trifluoromethane, difluoromethane, 1,1,1,3,3-pentafluorobutane, 1,1,1,3,3-pentafluoropropane, 1,1,1,2,3-pentafluoropropene, 1-chloro-3,3,3-trifluoropropene, 1,1,1,2-tetrafluoroethane, difluoroethane, and 1,1,1,2,3,3,3-heptafluoropropane, and also perfluoroalkanes, such as C₃F₈, C₄F₁o, C5F12, C6F14, and C₇F₁₇. Particular preference is given to hydrocarbons, preferably pentanes, in particular cyclopentane. The physical blowing agents mentioned can be used alone or in any desired combinations with one another.

When water is used as sole blowing agent, the quantity of water is then preferably from 0.05 to 3 parts by weight, based on the polyol components B and, if present, C. If a physical blowing agent is used, the quantity thereof is preferably from 0.1 to 30 parts by weight, based on the polyol component B, and, if present, C.

The foams are generally produced in a mold. The density of the foams is generally from 100 to 1000 kg/m³. Foams of this type are sometimes termed microcellular foams in the technical literature.

It is optionally also possible to add auxiliaries and/or additives G to the reaction mixture for the production of the polyurethane foams. Mention may be made by way of example of the following as auxiliaries and/or additives G: surface-active substances, foam stabilizers, cell regulators, other release agents, fillers, dyes, pigments, hydrolysis stabilizers, flame retardants, odor-absorbing substances, and fungistatic and/or bacteriostatic substances.

Examples of compounds which can be used as surface-active substances are those which serve to promote the homogenization of the starting materials and which optionally are also suitable for regulating the cell structure. Mention may be made by way of example of emulsifiers, for example the sodium salts of castor oil sulfates or of fatty acids, and also salts of fatty acids with amines, e.g. diethylamine oleate, diethanolamine stearate, and diethanolamine ricinoleate, salts of sulfonic acids, e.g. the alkali metal or ammonium salts of dodecylbenzene- or dinaphthylmethanedisulfonic acid, and ricinoleic acid; foam stabilizers, for example siloxane-oxalkylene copolymers and other organopolysiloxanes, ethoxylated alkylphenols, ethoxylated fatty alcohols, paraffin oils, castor oil esters or ricinoleic esters, Turkish red oil and peanut oil, and cell regulators, for example paraffins, fatty alcohols, polyoxyalkylene-polysiloxane copolymers, and dimethylpolysiloxanes. Oligomeric acrylates having, as pendant groups, polyoxyalkylene moieties and fluoroalkane moieties are moreover suitable for improving emulsifying action and the cell structure and/or stabilization of the foam. Quantities usually used of the surface-active substances are from 0.01 to 5 parts by weight, based on 100 parts by weight of component B and, if present, C.

Suitable Fillers, in particular reinforcing fillers, are the usual organic and inorganic fillers, reinforcing agents, weighting agents, coating agents, etc. known per se. Individual fillers that may be mentioned by way of example are: inorganic fillers, such as silicatic minerals, such as phyllosilicates, e.g. antigorite, bentonite, serpentine, hornblendes, amphiboles, chrysotile, and talc powder, metal oxides, e.g. kaolin, aluminum oxides, titanium oxides, zinc oxide, and iron oxides, metal salts, e.g. chalk and baryte, and inorganic pigments, e.g. cadmium sulfide, and zinc sulfide, and also glass, etc. It is preferable to use kaolin (China clay), aluminum silicate, and coprecipitates made of barium sulfate and aluminum silicate. It is also possible to add inorganic fibers, for example glass fibers. Examples of organic fillers that can be used are: carbon black, melamine, rosin, cyclopentadienyl resins, and graft polymers, and also cellulose fibers, polyamide fibers, polyacrylonitrile fibers, polyurethane fibers, polyester fibers based on aromatic and/or aliphatic dicarboxylic esters, and in particular carbon fibers.

The inorganic and organic fillers can be used individually or in the form of mixtures, and quantities thereof advantageously added to the reaction mixture are from 0.5 to 50% by weight, preferably from 1 to 40% by weight, based on the weight of components A to D.

The invention is explained in more detail via the examples below.

### EXAMPLES

An unfunctionalized polybutadiene is used, marketed with trademark Lithene® Ultra AL by Synthomer Ltd. Its number-average molar mass is 750 g/mol, and its composition, based on the quantity of all of the double bonds, comprises about 38 mol % of 1,4-cis/trans, about 36 mol % of 1,2 vinylic, and about 26 mol % of 1,2 cyclovinylic units.

The conversions of the double bonds during the epoxidation of polybutadienes were determined by ¹H NMR spectroscopy in d-chloroform.

The epoxide contents of the modified polybutadienes were determined by a method of Jung and Kleeberg, as described in Fres. J. Anal. Chem. 1962, 387. The OH numbers of the polyols were determined in accordance with DIN 53240-2 by means of potentiometric titration.

Dynamic shear viscosities were determined by using an AR-G2 rheometer from TA Instruments. The measurements were made at the stated temperature in steady-state mode with shear frequencies from 0.1 to 100 Hz, using cone-on-plate geometry (diameter: 40 mm, angle:)2°.

Glass transition temperatures were determined by means of DSC. Uncrosslinked materials were cooled from room temperature to −100° C. at a rate of 10° C./min. The temperature was maintained for a period of 4 min. Finally, the temperature was increased to 100° C. at a rate of 10° C./min, and glass transition temperature was determined in this heating phase at the inflection point of the heat flux curve. The crosslinked materials were first heated to 100° C. within a period of 12 minutes and then cooled to −90° C. within a period of 22 minutes. In the second heating phase the temperature was increased to 255° C. at 20° C./min. Glass transition temperature was determined in the second heating phase at the inflection point of the heat flux curve.

The tensile tests were carried out in accordance with DIN 53504 on S2 dumbbell specimens with optical displacement monitoring. Shore hardness values were determined in accordance with DIN 53505.

Water absorption was determined on PUR plaques cut to the precise size required for photographic slide frames, measuring about 3×4 cm². The specimens were placed in water at a temperature of 100° C. for a period of five hours. Finally, the specimens were dabbed dry, and the degree of swelling was calculated from the mass difference.

### Inventive Example 1

### Production of Partially Epoxidized Polybutadiene Oligomers

1000 g of Lithene® Ultra AL were dissolved in 5667 g of toluene in a 10 L conical steel reactor and heated to 60° C. After addition of 43.8 g of 98% formic acid, the mixture was intimately mixed at 300 rpm. 70, 100, or 130 mL/hour of hydrogen peroxide were added continuously over a period of 7.5 hours. The reaction mixture was then washed twice with saturated sodium hydrogencarbonate solution and once with saturated sodium chloride solution. The organic phase was dried with sodium sulfate, and the solvent was removed under reduced pressure at 60° C. Table 1 collates the properties of the resultant pale yellow, viscous oils.

TABLE 1
Partially epoxidized polybutadienes

| Description | EPB 1 | EPB 2 | EPB 3 |
|---|---|---|---|
| H₂O₂ metering rate [mL/h] | 70 | 100 | 130 |
| Yield [g] | 966.1 | 1011.1 | 1015.3 |
| Epoxide content [%]¹ | 20.0 | 24.2 | 27.3 |
| Epoxide content [mol/100 g] | 0.225 | 0.261 | 0.291 |
| Tg [° C.] | −40.0 | −37.9 | −35.5 |
| η @ 40° C. [Pa · s] | 4.66 | 6.00 | 7.47 |

¹based on all of the double bonds of the starting material

### Inventive Example 2

### Production of Polybutadiene Polyols

The partially epoxidized Lithene® Ultra AL materials (900 g for the production of polyols 1 and 2 and 450 g for the production of polyol 3) in 1800 g of 1-propanol were heated and dissolved at the stated temperature in a 6 L glass reactor. After addition of an appropriate quantity of a 10% solution of trifluoromethanesulfonic acid (TfOH) in 1-propanol, the mixture was stirred for the stated time. The mixture was then neutralized with sodium hydrogencarbonate, and undissolved salt was removed by filtration after cooling of the mixture. Excess 1-propanol was removed from the filtrate under reduced pressure at up to 95° C. Table 2 collates the properties of the resultant pale yellow, viscous oils.

TABLE 2
Hydroxy-modified polybutadienols

| | Polyol 1 | Polyol 2 | Polyol 3 |
|---|---|---|---|
| | Epoxidized PB | | |
| Description | EPB 1 | EPB 2 | EPB 3 |
| Temperature [° C.] | 70 | 70 | 70 |
| Reaction time [h] | 8 | 6 | 8 |
| TfOH [ppm] | 80 | 100 | 100 |
| Epoxide moiety [mol/100 g] | 0.005 | 0.007 | 0.012 |
| OH number [mg KOH/g] | 107.7 | 115.8 | 138.9 |
| Equivalent mass | 521 | 484 | 404 |
| Tg [° C.] | −22.6 | −16.8 | −12.1 |
| η [Pa · s] at 40° C. | 34.3 | 61.6 | 126.1 |

### Inventive Example 3

### Production of a Glassy Polyurethane

For processing to give the polyurethane, the polybutadiene polyols from table 2 and polymeric MDI (Lupranat® M20 from BASF SE, Ludwigshafen, DE) with NCO value 31.5% were maintained at a temperature of 60° C. The polyol component optionally comprised, alongside the polybutadiene polyol, a mercury salt as catalyst. The components were mixed in a high-speed mixer from Hausschild GmbH for one minute at 2000 rpm.

For production of PUR 2, 62.74 g of polybutadienol 4 were weighed with 0.07 g of catalyst in a beaker for the A component, and mixed in the high-speed mixer to give a bubble-free mixture. The A component was then stored for at least 30 minutes at 60° C. (processing temperature) before the isocyanate component B was added. B component and A component were mixed. The mixture was poured into an aluminum mold measuring about 150×200×2 mm³ maintained at 70° C., and smoothed with a plastics rod. 20 minutes after setting (open time; processing time at 70° C.), the material was demolded and maintained at 80° C. for 4 hours. The transparent glossy polyurethane was stored for at least 7 days at 23° C. and 50% humidity prior to characterization.

Table 3 collates the properties of polyurethanes made of polybutadienols.

TABLE 3
Glassy PUR materials

| Description | PUR 1 | PUR 2 | PUR 3 |
|---|---|---|---|
| Polyol | Polyol 1 | Polyol 2 | Polyol 3 |
| Index | 100 | 100 | 100 |
| Catalyst | 0.1 | 0.1 | 0.1 |
| Open time at 70° C. [min] | 4.1 | 3.6 | 2.8 |
| Tg [° C.] | 32.0 | 44.9 | 59.1 |
| Modulus of elasticity [MPa] | 622 | 1090 | 1800 |
| Tensile strength [MPa] | 19.9 | 32.2 | 44.8 |
| Tensile strain at break [%] | 30.7 | 4.6 | 5.8 |
| Shore D | 71 | 79 | 81 |
| Degree of swelling [%] | 0.59 | 0.50 | 0.43 |

### Comparative of Example 1

Another unfunctionalized polybutadiene marketed with trademark Lithene® Ultra PM4 by Synthomer was reacted. In contrast to the Lithene® Ultra AL described, its number-average molar mass is 2000 g/mol and its 1,2 vinylic and 1,2 cyclovinylic content is in total 21%, based on the quantity of all of the double bonds. A Lithene® Ultra AL polybutadiene was also used. The epoxidation of Lithene® Ultra PM4 and Lithene® Ultra AL proceeded as in inventive example 1, and gave partially epoxidized polybutadiene oligomers with the properties collated in table 4.

TABLE 4
Partially epoxidized polybutadienes

| Description | EPB 4 | EPB 5 |
|---|---|---|
| Type of polybutadiene | Lithene ® | Lithene ® |
| | Ultra AL | Ultra PM4 |
| H₂O₂ metering rate [mL/h] | 30 | 50 |
| Epoxide content [%]¹ | 9.3 | 14.9 |
| Epoxide content [mol/100 g] | 0.125 | 0.225 |
| Tg [° C.] | −48.2 | −76.1 |
| η at 40° C. [Pa · s] | 2.24 | 0.986 |

¹based on all of the double bonds of the starting material

### Comparative Example 2

Opening of the epoxy groups of the partially epoxidized polybutadienes from table 4 by 1-propanol, as in inventive example 2, gave polybutadienols with the properties collated in table 5.

TABLE 5
Hydroxy-modified polybutadienols

| | |
|---|---|
| Polyol 4 | Polyol 5 |

Epoxidized PB

| Description | EPB 4 | EPB 5 |
|---|---|---|
| Temperature [° C.] | 80 | 70 |
| Reaction time [h] | 6 | 6 |
| TfOH [ppm] | 80 | 100 |
| Epoxy moiety [mol/100 g] | 0.005 | 0.012 |
| OH number [mg KOH/g] | 60.0 | 112.0 |
| Equivalent mass | 936 | 501 |
| Tg [° C.] | −40.0 | −65.9 |
| η [Pa · s] at 40° C. | 5.33 | 3.68 |

### Comparative Example 3

Crosslinking of the polybutadiene polyols from table 5 with isocyanates, corresponding to inventive example 3, gave materials with the properties collated in table 6.

TABLE 6
PUR materials

| Description | PUR 4 | PUR 5 |
|---|---|---|
| Polyol | Polyol 4 | Polyol 5 |
| Index | 100 | 100 |
| Catalyst | 0.1 | 0.1 |
| Open time at 70° C. [min] | 4.6 | 9.2 |
| Tg [° C.] | −13.5 | −22.1 |
| Modulus of elasticity [MPa] | 0.92 | 6.78 |
| Tensile strength [MPa] | 1.42 | 6.4 |
| Tensile strain at break [%] | 95 | 76 |
| Shore D | <10 | 20 |
| Degree of swelling [%] | 0.50 | 0.54 |

The inventive examples and comparative examples show that, even with high hydroxy equivalent masses, the polybutadienols can be reacted to give crosslinked polyurethanes with glass transition temperatures above 25° C. By virtue of the hydrophobic property of the polybutadiene, the materials exhibit very low degrees of swelling in water. The polymers moreover comprise no reaction sites susceptible to hydrolysis. The omission of a catalyst allows production of formulations with substantially longer pot lives prior to crosslinking of the material. Pot life can be shortened as desired by adding a catalyst, whereupon the properties of the resultant polyurethanes remain in essence unaltered.

1. A process for the production of polybutadienols having a hydroxy equivalent mass from 250 to 750 g from polybutadienes with number-average molar mass from 300 to 2000 g/mol comprising from 20 to 50% of 1,4 double bonds and from 50 to 80% of 1,2 vinylic and 1,2 cyclovinylic double bonds, based on [[the]] a quantity of all of the double bonds, comprising the steps of
i) epoxidation of at least one of the 1,4 double bonds with an epoxidizing reagent which selectively epoxidizes 1,4 double bonds, and
ii) reaction of the epoxidized polybutadiene with a monoalcohol or water to give a polybutadienol.

2. The process according to claim 1, wherein the epoxidizing reagent is performic acid.

3. The process according to claim 1, wherein the monoalcohol is a primary alcohol.

4. The process according to claim 3, wherein the monoalcohol is selected from the group consisting of ethanol, 1-propanol, and 1-butanol.

5. A polybutadienol obtainable by the process according to claim 1.

6. The polybutadienol according to claim 5, which comprises>90% of secondary OH groups, based on a quantity of all of the OH groups.

7. A polyurethane with glass transition temperature at least 15° C., obtainable via reaction of;
a) polyisocyanates A with
b) polybutadienols B according to claim 5.

8. (canceled)

9. The polyurethane according to claim 7, obtainable via reaction of:
a) polyisocyanates A with
b) polybutadienols B according to claim 5, and
c) other compounds C having at least 2 hydrogen atoms reactive toward isocyanates.

10. The polyurethane according to claim 7, obtainable via reaction of:
a) polyisocyanates A with
b) polybutadienols B according to claim 5, and
d) catalysts D.

11. The polyurethane according to claim 7, obtainable via reaction of:
a) polyisocyanates A with
b) polybutadienols B according to claim 5, and
e) water E.

12. The polyurethane according to claim 7, obtainable via reaction of:
a) polyisocyanates A with
b) polybutadienols B according to claim 5, and
f) physical blowing agents F.

13. The polyurethane according to claim 7, obtainable via reaction of:
a) polyisocyanates A with
b) polybutadienols B according to claim 5, and
g) other auxiliaries and/or additives G.
